(19) United States
(12) Patent Application Publication
(10) Pub. No.: US 2007/0175729 A1
(43) Pub. Date: Aug. 2, 2007

(54) RETRACTABLE STOP ASSEMBLY

(76) Inventors: Brian Owen Robinson, Ypsilanti, MI (US); Timothy N. Thomas, St. Clair Shores, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/275,861

(22) Filed: Feb. 1, 2006

(51) Int. Cl. B65G 13/00

(52) U.S. Cl. 193/35 A

(57) ABSTRACT

A power operated retractable stop assembly includes a body, a drive arm, and a stop arm. The drive arm is pivotable between a pre-locked position and an unlocked position. There is a locked position between the pre-locked position and the unlocked position. The stop arm is pivotally mounted to the body, has a front side for engaging a workpiece, and a back side for engaging the drive arm. A rotary driving means is connected to a reciprocatable member that drives the drive arm.

### BACKGROUND OF THE INVENTION

1. Field of the Invention

The invention relates to power operated retractable stop assemblies.

2. Background Art

The use of industrial retractable stop products has become wide spread, due at least in part to high demands in the automotive and heavy equipment industries. Conventionally, a retractable stop is powered by a linear actuator such as an air or hydraulic cylinder, a solenoid actuator, or a rotary actuator with a linear worm gear.

A power operated retractable stop assembly typically includes a reciprocatable rod member driven by the linear actuator, and an assembly body secured to the driving cylinder. Some of these existing assemblies, such as those described in U.S. Pat. No. 4,184,579, utilize a stop lever for stopping and releasing loads traveling on a conveyor. In such an assembly, a blocker leg is used to prevent pivoting of the stop arm causing an uncushioned hard stop of loads traveling on the conveyor when the blocker leg is in the blocking position.

Other existing assemblies attempt to provide a cushioned stop by using cylinder pressure to hold the stop arm in the blocking position. However, assemblies such as these may be disadvantageous in that there is no guarantee of a stop, and a heavy load may deflect the stop lever against the biasing cylinder pressure and continue right past the retractable stop without stopping. Sometimes, assemblies utilize a first mechanism for actuating and deactuating the stop and utilize a separate shock absorber mechanism, such as the assembly described in U.S. Pat. No. 5,168,976.

Other existing assemblies use a linear actuator rod interfering at a right angle with the direction of travel of the conveyor load. This has the disadvantage of side loading the actuator which is designed for the loads to be in line with the center line of the actuator. This creates excessive wear of the actuator. Also, excessive side load on a linear actuator can cause the actuator to bind and be unable to release without first releasing the load.

Although the existing retractable stop assemblies that provide a hard stop and those assemblies that attempt to provide a cushioned stop by using cylinder pressure have been used in many applications that have been commercially successful, these assemblies have disadvantages. In some applications, it may be desirable to provide a cushioned stop, and assemblies providing a hard stop without any cushion may not be desired. Further, although a cushion may be desirable in some applications, because assemblies providing a cushioned stop cannot guarantee a stopping of the load after the cushion, these assemblies may also not be desired. Further, assemblies utilizing a separate shock absorber mechanism are complex and costly, so these assemblies may also not be desired.

Power operated retractable stop assemblies with integral cushion and stopping mechanisms are described in U.S. Pat. No. 6,119,843. These power operated retractable stop assemblies provide a cushion when stopping a load and provide a hard stop at the end of the cushion zone. These existing retractable stop assemblies that provide integral cushion and stopping mechanisms have also been used in applications that have been commercially successful.

There is an opportunity for improvement in power operated retractable stop assemblies with integral cushion and stopping mechanisms due to the fact that the parts required to mount and connect the linear actuator have significant costs. Accordingly, there is a need for an improved power operated retractable stop assembly.

### SUMMARY OF THE INVENTION

It is an object of the invention to provide a power operated retractable stop assembly in which a reciprocating rotary actuator mounts on the side of the stop assembly with a through shaft at the pivot point of the drive arm. This makes it possible to eliminate some internal parts that were previously used to mount and connect a linear actuator, resulting in significant cost reduction.

The invention involves a power operated retractable stop assembly. The assembly comprises a body, a reciprocatable member, a drive arm, and a stop arm. The reciprocatable member extends at least partially into the body and is adapted to engage a rotary driving means such as a motor or rotary actuator. The reciprocatable member is driveable between a first angular position and a second angular position. The drive arm is pivotally mounted to the body and drivingly connected to the reciprocatable member such that the drive arm is pivoted about a drive axis. The drive arm is pivotable over a motion range between a pre-locked position and an unlocked position in response to movement of the reciprocatable member. The motion range includes a locked position between the pre-locked position and the unlocked position. The drive arm has a central axis passing through the drive axis to define a drive arm plane that pivots with the drive arm.

The stop arm is pivotally mounted to the body such that the stop arm is pivotable about a stop axis. The stop arm has a front side for engaging a workpiece and a back side for engaging the drive arm. The stop arm is positioned to apply a reaction force to the drive arm in response to a force exerted on the stop arm front side by a workpiece.

The stop arm back side is configured such that the reaction force has a component normal to the drive arm plane when the drive arm is between the pre-locked position and the locked position. The normal component of the reaction force urges the drive arm toward the locked position. Further, the stop arm back side is configured such that the reaction force is substantially coplanar with the drive arm plane when the drive arm is in the locked position to cause the drive arm to remain at the locked position.

In accordance with the invention, the rotary driving means and the reciprocatable member cooperate to form a reciprocating rotary actuator that drives the drive arm. In the preferred embodiment of the invention, the rotary actuator mounts on the side of the stop assembly with a through shaft at the pivot point of the drive arm.

### BRIEF DESCRIPTION OF THE DRAWINGS

FIG. 1 is a perspective view of a power operated retractable stop assembly in a preferred embodiment of the invention;

FIG. 2 is a side view of the stop assembly;

FIG. 3 is a side view, in section, of the stop assembly;

FIG. 4 is an end view of the stop assembly;

FIG. 5 is a schematic diagram that illustrates the pre-locked, locked, and unlocked positions for the stop assembly;

FIG. 6 is a cross-section view through the stop assembly showing the reciprocating rotary actuator mounted on the side of the stop assembly in the preferred embodiment of the invention; and

FIG. 7 is a side view of the drive arm used with the rotary actuator.

### DETAILED DESCRIPTION OF THE PREFERRED EMBODIMENT

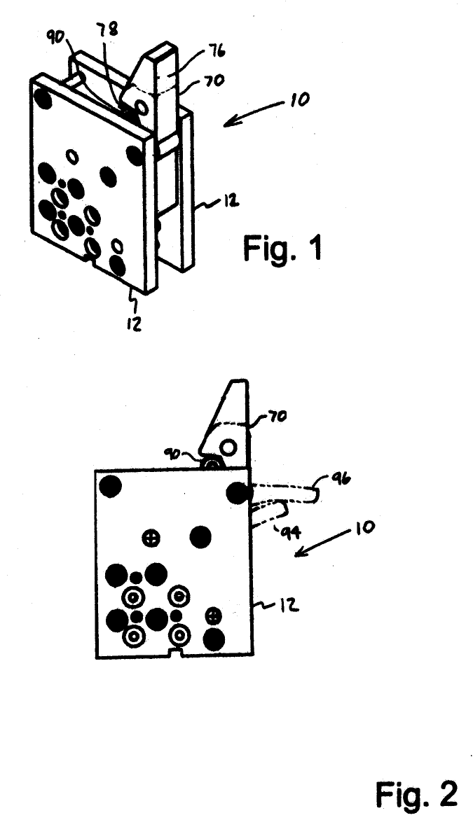

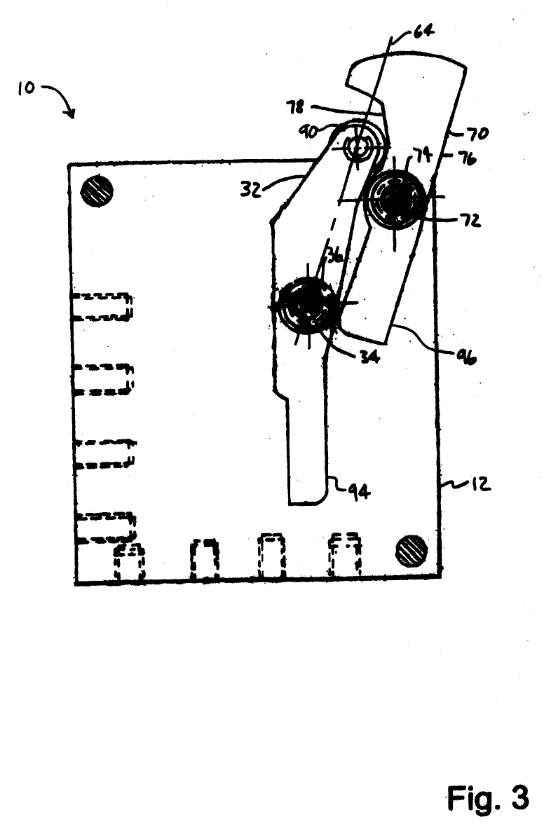

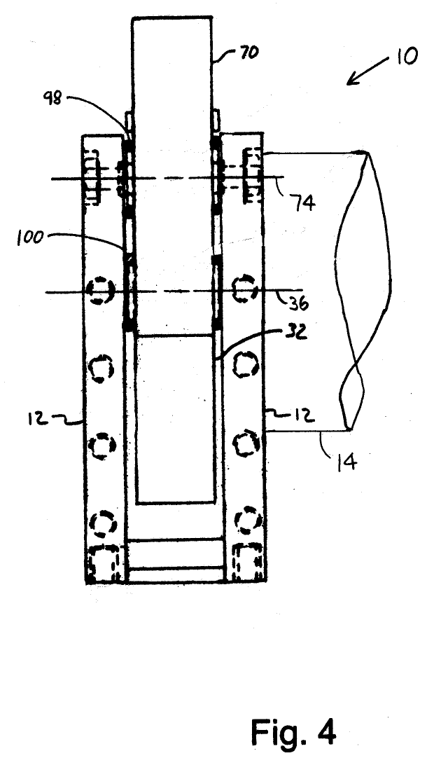

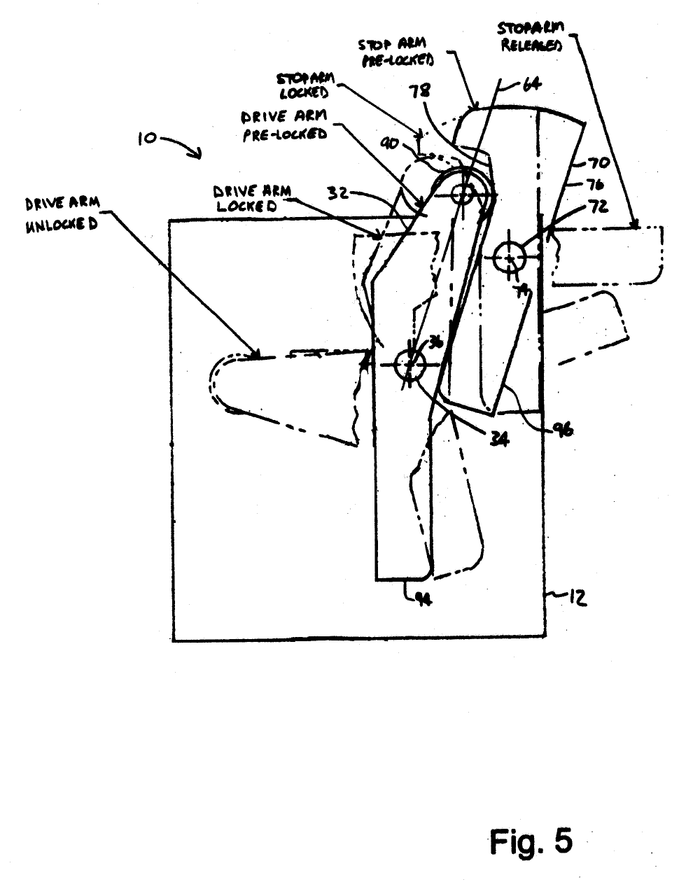

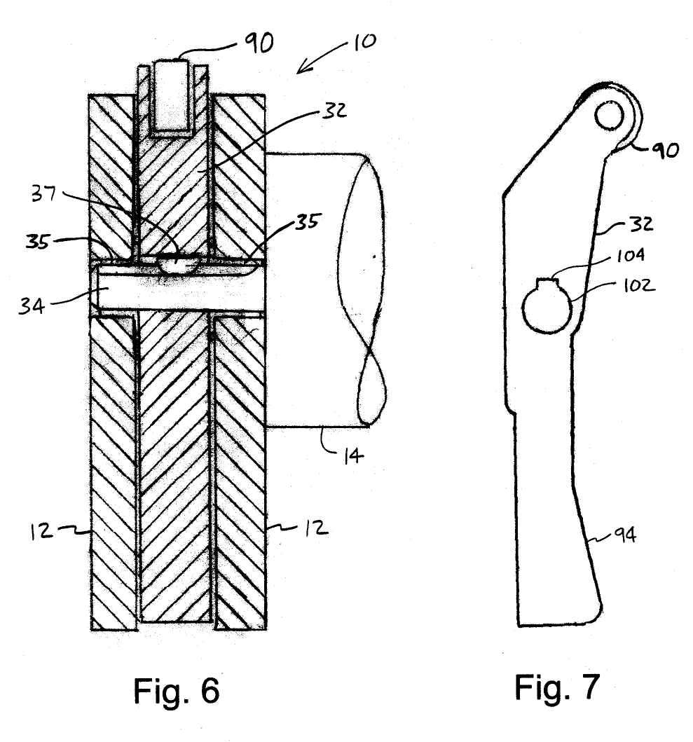

Referring to FIGS. 1-5 which illustrate a power operated retractable stop assembly, and primarily to FIGS. 3 and 5, the stop assembly is generally indicated at 10. FIGS. 1-5 illustrate the stop assembly and the integral cushion and stopping mechanisms while FIGS. 6-7 illustrate the rotary actuator and drive arm configuration in the preferred embodiment of the invention. Stop assembly 10 has a body composed of sides 12. A rotary driving means 14 engages the assembly body. A suitable rotary driving means is a motor or rotary actuator. The rotary actuator may be pneumatic, hydraulic or electric. An air powered actuator is suitable for providing a cushioning zone due to the compressability of gas. Alternatively, a hydraulic actuator with a pressure relief valve may be employed to provide the cushioning zone. An electric actuator must be back driveable to provide cushion and stallable at both ends of rotation as normal operation.

The rotary driving means 14 and a reciprocatable member such as shaft 34 cooperate to form a reciprocating rotary actuator drivable between a first angular position and a second angular position.

A drive arm 32 is pivotally mounted to body 12. Shaft 34 and a suitable bearing arrangement 35 mount drive arm 32 to body 12, and prevent rotational and side thrust friction and wear. Drive arm 32 is pivotable about drive axis 36.

As best shown in FIG. 5, drive arm 32 is pivotable about drive axis 36 over a motion range between a pre-locked position and an unlocked position (shown in phantom). Further, the motion range includes a locked position (also shown in phantom) between the pre-locked and unlocked positions.

Shaft 34 is in a first angular position when drive arm 32 is in the pre-locked position, and is in a second angular position when drive arm 32 is in the unlocked position. Shaft 34 moves to an intermediate position when drive arm 32 is in the locked position.

With continuing reference to FIG. 5, drive arm 32 moves over its motion range in response to movement of shaft 34, which is driven by rotary driving means 14. Drive arm 32 has a central axis 64 passing through drive axis 36 to define a drive arm plane that pivots with the drive arm. The drive arm plane rotates as drive arm 32 rotates.

Stop assembly 10 also includes a stop arm 70. Stop arm 70 is affixed to body 12 by pin and bearing assembly 72, which extends through body 12 and prevents rotational and side thrust friction and wear. Stop arm 70 is pivotable about a stop axis 74. Stop arm 70 has a front side 76 for engaging a workpiece and a back side 78 for engaging drive arm 32. Stop arm 70 is arranged to apply a reaction force to drive arm 32 in response to a force exerted on front side 76.

As best shown in FIG. 5, stop arm back side 78 is configured such that a reaction force applied by stop arm back side 78 to drive arm 32 in response to the force of a workpiece on stop arm 70 has a component that is normal to the drive arm plane 64 when the drive arm 32 is between the pre-locked position and the locked position. Because drive axis 36 lies in the drive arm plane, forces normal to the drive arm plane urge the drive arm 32 toward the locked position through a cushioning zone provided by the driving means 14. As such, configuring stop arm back side 78 such that the reaction force has a component normal to the drive arm plane when drive arm 32 is between the pre-locked position and the locked position causes drive arm 32 to be urged to the locked position whenever a workpiece contacts stop arm 70 and the drive arm is between the pre-locked position and the locked position.

Further, when drive arm 32 reaches its locked position, the configuration of stop arm back side 78 causes the reaction force applied by stop arm back side 78 to drive arm 32 to be substantially coplanar with the drive arm plane. Because drive arm axis 36 lies in the drive arm plane, substantially coplanar reaction forces are opposed by shaft 34 and bearing assembly 35, and do not cause drive arm 32 to rotate out of the locked position.

Advantageously, shaft 34 and bearings 35 hold the stop assembly 10 in the locked position against the force of any load or workpiece. After drive arm 32 and stop arm 70 have remained in the locked positions for a desired amount of time, rotary driving means 14 may be actuated to urge drive arm 32 to the unlocked position causing stop arm 70 to pivot and allow the workpiece to pass.

The illustrated embodiment provides a cushioning zone between the pre-locked and locked positions in which the amount of cushion may be determined by selecting appropriate lever arm lengths, pivot point positions, and actuator resistance torque. After the cushioning zone, a hard stop is provided. Advantageously, the hard stop directs all force from the workpiece in a direction coplanar with the drive arm plane such that this reaction force is received by shaft 34 and bearing assembly 35 almost in its entirety.

Cam roller 90, located at the end of drive arm 32, is positioned to engage stop arm back side 78. The freely rotating roller eliminates friction that could prevent release of the mechanically locked arms while under load from conveyor travel. This roller 90 also reduces friction between the arms when moving from release positions to ready or pre-locked positions and from ready or pre-locked positions to locked positions during shock absorbing action.

With continuing reference to FIGS. 1-5, and as best shown in FIG. 5, drive arm 32 at one end engages stop arm back side 78 and at the other end has a leg 94. Stop arm 70 has a leg 96. Drive arm lower leg 94 is below the drive arm pivot and stop arm leg 96 is below the stop arm pivot. When drive arm 32 is driven to the drive arm unlocked or released position, lower leg 96 of stop arm 70 rides on lower leg 94 of drive arm 32 to cause stop arm 70 to automatically follow drive arm 32 and move to the stop arm released position under power. This precludes stop arm 70 from balancing at the ready or locked position which would be problematic in certain situations. It is appreciated that this interaction of stop arm 70 and drive arm 32 may be achieved in various ways, and is achieved through the interaction of stop arm lower leg 96 and drive arm lower leg 94 in the preferred embodiment.

FIGS. 6 and 7 illustrate the rotary actuator and drive arm configuration in the preferred embodiment of the invention. Rotary driving means 14 and reciprocatable shaft 34 cooperate to form the reciprocating rotary actuator that drives drive arm 32. The rotary actuator is mounted to side plate 12 of the stop assembly 10 with shaft 34 located at the pivot point of drive arm 32. This arrangement makes it possible to eliminate some internal parts that would have been required to mount and connect a linear actuator, resulting in significant cost savings in the preferred embodiment of the invention.

In more detail, drive arm 32 has a bore 102 at the pivot point to accommodate shaft 34. Key way 104 is cut to match key 37 in the actuator shaft 34. In the preferred embodiment, drive arm 32 has deformations at each end of the key way 104 so that key 37 cannot slide laterally past the end of the key way 104 in drive arm 32. Bore 102 has a diameter to slip fit on the shaft 34. Bearings 35 have an inside diameter to slip fit with the rotary actuator shaft 34 and an outside diameter to press fit in the pivot holes of side plates 12. The rotary driving means may be mounted to either side plate 12 by providing, for example, four tapped holes around the drive arm pivot point. Because the actuator could mount interchangeably on either side of the stop assembly 10, varied application conditions may be accommodated.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A power operated retractable stop assembly comprising:
a body;
a reciprocatable member extending into the body and being driveable between a first angular position and a second angular position;
a rotary driving means connected to the reciprocatable member;
a drive arm pivotally mounted to the body and drivingly connected to the reciprocatable member such that the drive arm is pivotable about a drive axis over a motion range between a pre-locked position and an unlocked position in response to movement of the reciprocatable member, the motion range including a locked position between the pre-locked position and the unlocked position, and the drive arm having a central axis passing through the drive axis to define a drive arm plane that pivots with the drive arm; and
a stop arm pivotally mounted to the body such that the stop arm is pivotable about a stop axis, the stop arm having a front side for engaging a workpiece and a back side for engaging the drive arm, the stop arm being positioned to apply a reaction force to the drive arm in response to receiving a force exerted on the stop arm front side by a workpiece,
wherein the stop arm back side is configured such that the reaction force has a component normal to the drive arm plane when the drive arm is between the pre-locked position and the locked position to urge the drive arm toward the locked position, and such that the reaction force is substantially coplanar with the drive arm plane when the drive arm is in the locked position to cause the drive arm to remain at the locked position with the stop arm held at a stop arm locked position.

2. The stop assembly of claim 1 wherein when the drive arm is in its locked position and the stop arm is in the stop arm locked position, the stop arm is mechanically locked by the drive arm without assistance from the rotary driving means.

3. The stop assembly of claim 1 wherein when the drive arm is driven to the unlocked position, the drive arm and the stop arm interact to cause the stop arm to follow the drive arm and move to a stop arm released position, precluding the stop arm from balancing at the stop arm locked position.

4. The stop assembly of claim 3 wherein:
the drive arm has a first end that engages the stop arm back side and a second end, the drive arm having a leg extending toward the drive arm second end;
wherein the stop arm has a first end that engages the workpiece and a second end, the stop arm having a leg extending toward the stop arm second end; and
wherein when the drive arm is driven to the unlocked position, the stop arm leg rides on the drive arm leg to cause the stop arm to follow the drive arm and move to the stop arm released position.

5. The stop assembly of claim 1 wherein the drive arm has an end, and the stop assembly further comprises:
a roller located at the drive arm end and positioned to engage the stop arm back side, the roller having an axis of rotation that is substantially parallel to the drive axis and is substantially coplanar with the drive arm plane.

6. The stop assembly of claim 1 wherein the driving means comprises:
a rotary actuator assembly engaging the reciprocatable member for driving the reciprocatable member.

7. The stop assembly of claim 1 wherein the driving means comprises:
a motor assembly engaging the reciprocatable member for driving the reciprocatable member.

8. The stop assembly of claim 1 wherein the rotary driving means and the reciprocatable member cooperate to form a reciprocating rotary actuator that drives the drive arm.

9. The stop assembly of claim 8 wherein the reciprocating rotary actuator mounts on the side of the stop assembly with the reciprocatable member at the pivot point of the drive arm.
